(19) United States
(12) Patent Application Publication
(10) Pub. No.: US 2025/0299287 A1
(43) Pub. Date: Sep. 25, 2025

(54) TIME-ADJUSTED INTERPOLATED FRAME DISPLAY

(71) Applicant: ADVANCED MICRO DEVICES, INC., Santa Clara, CA (US)

(72) Inventors: Colin Riley, Edinburgh (GB); Stefan Jimmy Petersson, Stockholm (SE); Stephan Hodes, Munich (DE); Oskar Johannes Homburg, Munich (DE)

(21) Appl. No.: 18/615,997

(22) Filed: Mar. 25, 2024

(51) Int. Cl. G06T 1/20; G06T 11/00

(52) U.S. Cl. CPC G06T 1/20; G06T 11/00; G06T 2200/24

(57) ABSTRACT

To improve the framerate of a set of rendered frames, a processing system is configured to generate and display one or more interpolated frames. To this end, the processing system includes an accelerator unit (AU) configured to generate an interpolated frame from a first rendered frame and a second rendered frame of the set of rendered frames. The AU then determines a timing to display the interpolated frame based on tracked rendering metrics associated with the interpolated frame, first rendered frame, and the second rendered frame. The AU then provides the interpolated frame to a display based on the determined timing.

### BACKGROUND

Some graphics applications reduce or fix the framerate at which frames are rendered in order to reduce the processing resources required to produce a set of rendered frames. To compensate for this reduction in framerate, some processing systems implement frame interpolation techniques so as to generate one or more interpolated frames from two or more rendered frames within a set of rendered frames. These generated interpolated frames each represent frames that come temporally and spatially between two or more respective rendered frames. After generating the interpolated frames, the processing systems then insert the interpolated frames into the set of rendered frames. By inserting the interpolated frames into the set of rendered frames, the number of frames within the set of rendered frames is increased, which serves to increase the framerate of the set of rendered frames. However, due to delays in rendering the rendered frames or delays in generating the interpolated frames, some interpolated frames are likely to be presented at a framerate different from this increased frame. Because these interpolated frames are presented at a different framerate, visual distortions within the interpolated frames are likely to occur such as screen tears and the blurring of objects, which negatively impacts user experience.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of a processing system configured to determine timing data for the presentation of interpolated frames, in accordance with some embodiments.

FIG. 2 is a block diagram of a graphics pipeline implemented by an accelerator unit, in accordance with some embodiments.

FIG. 3 is a flow diagram of an example operation for determining timing data for the presentation of interpolated frames, in accordance with some embodiments.

FIG. 4 is a flow diagram of an example operation for determining timing data for interpolated frames using asynchronous computing, in accordance with some embodiments.

FIG. 5 is a flow diagram illustrating an example method for determining timing data for the presentation of interpolated frames, in accordance with some embodiments.

### DETAILED DESCRIPTION

Some processing systems are configured to execute applications that render sets of rendered frames to be presented on a display. Each of these rendered frames, for example, represents a scene with one or more graphics objects (e.g., groups of primitives) as viewed by a respective viewpoint (e.g., camera view). In this way, as the set of rendered frames is displayed, the viewpoint of the scene changes which causes pixels representing the graphics objects to be viewed at a first position when a first rendered frame is displayed and at a second position when a second rendered frame is displayed. To help improve processing efficiency, some applications are configured to lower the framerate at which these rendered frames are rendered such that the resulting set of rendered frames has a reduced number of rendered frames and requires fewer processing resources to render. However, lowering the framerate in this way causes the set of rendered frames to display at a lower framerate, causing movement of the pixels representing the graphics objects to appear less smooth and negatively impacting user experience. To this end, systems and techniques disclosed herein include a processing system configured to generate one or more interpolated frames that each represent a scene with a respective viewpoint that is temporally between, spatially between, or both temporally and spatially between two or more rendered frames of the set of rendered frames. For example, based on a first rendered frame (e.g., a previous rendered frame) and a second rendered frame (e.g., a current rendered frame), a processing system is configured to generate an interpolated frame that represents a scene with a respective viewpoint that is temporally between, spatially between, or both temporally and spacially between the first and second rendered frames. After generating the interpolated frame, the processing system inserts the interpolated frame into the set of rendered frames between the first and second rendered frames used to generate the interpolated frame. After inserting one or more interpolated frames into the set of rendered frames, the processing system displays the set of rendered frames. Due to the set of rendered frames including one or more interpolated frames, the number of frames within the set of rendered frames is increased, increasing the framerate of the set of rendered frames when it is displayed to a target framerate. Because the framerate of the set of rendered frames is increased to the target framerate, the motion of the pixels representing the graphics objects appears smoother when displayed, which improves user experience.

However, when rendering a set of rendered frames and generating the interpolated frames, certain conditions arise that cause interpolated frames to be displayed at a different framerate from the target framerate (e.g., the framerate as increased by the interpolated frames), a refresh rate of a display, or both. As an example, delays in the rendering of rendered frames, delays in the generation of interpolated frames, or both increase the likelihood that one or more interpolated frames are presented at a different framerate than the target framerate, the refresh rate of a display, or both. Presenting these interpolated frames at a different framerate than the target framerate, the refresh rate of a display, or both increases the likelihood of introducing visual distortions when the interpolated frames are displayed such as screen tears, blurred objects, and the like. To this end, systems and techniques disclosed herein are directed to helping ensure that interpolated frames are presented at the same framerate as a target framerate, the refresh rate of a display, or both. To help ensure that interpolated frames are presented at the same framerate as a target framerate, the refresh rate of a display, or both, a processing system includes an accelerator unit (AU) that includes a timing circuitry. Such a timing circuitry, for example, is configured to determine a corresponding timing at which to present one or more generated interpolated frames such that the interpolated frames are presented at the same framerate as the target framerate, the refresh rate of a display, or both.

To determine a timing at which to present an interpolated frame (e.g., interpolated frame timing), the timing circuitry is configured to determine rendering metrics associated with the interpolated frame. For example, the timing circuitry is configured to determine the rendering metrics of the rendered frames used to generate the interpolated frame and the rendering metrics of the interpolated frame. These rendering metrics include, for example, include timing information indicating the respective times it took to render the rendered frames, the respective times to took to render a user interface (UI) in the rendered frames, the respective times the rendered frames where presented, the time it took to generate the interpolated frame, the time it took to render a UI in the interpolated frame, or any combination thereof. After determining one or more rendering metrics associated with the interpolated frame, the timing circuitry determines an interpolated frame timing based on the determined rendering metrics. For example, the AU first determines if there will be a delay in the presentation of the interpolated frame by comparing one or more determined rendering metrics to one or more predetermined thresholds. After determining there will be a delay in the presentation of the interpolated frame, the AU determines the length of the delay by, for example, combining (e.g., adding) one or more of the determined rendering metrics. The AU then compares the combined rendering metrics to the target framerate, refresh rate of a display, or both to determine an interpolated frame timing. As an example, based on a comparison of the combined rendering metrics to the target framerate, refresh rate of a display, or both, the AU determines an interpolated frame timing such that the interpolated frame will be presented in accordance with the target framerate, the refresh rate of a display, or both. Due to the timing circuitry determining an interpolated frame timing such that an interpolated frame is presented in accordance with the target framerate, refresh rate of a display, or both, the likelihood that the presentation of the interpolated frame introduces a visual distortion (e.g., screen tear, blurred object) is reduced. As such, in this way, the processing system is able to increase the framerate of a set of rendered frames by generating and displaying one or more interpolated frames while also reducing the likelihood that presenting such interpolated frames introduces visual distortions.

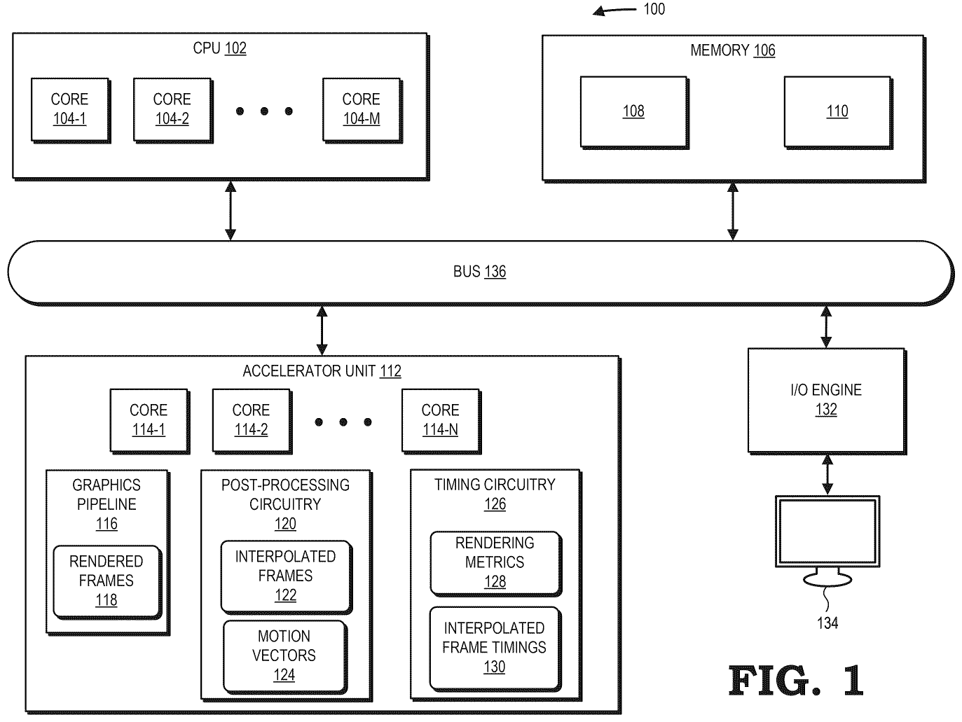

Referring now to FIG. 1, a processing system 100 configured to determine timing data for the presentation of interpolated frames is presented, in accordance with some embodiments. Processing system 100 includes or has access to a memory 106 or other storage component implemented using a non-transitory computer-readable medium, for example, a dynamic random-access memory (DRAM). However, in implementations, the memory 106 is implemented using other types of memory including, for example, static random-access memory (SRAM), nonvolatile RAM, and the like. According to implementations, the memory 106 includes an external memory implemented external to the processing units implemented in the processing system 100. The processing system 100 also includes a bus 136 to support communication between entities implemented in the processing system 100, such as the memory 106. Some implementations of the processing system 100 include other buses, bridges, switches, routers, and the like, which are not shown in FIG. 1 in the interest of clarity.

The techniques described herein are, in different implementations, employed at accelerator unit (AU) 112. AU 112 includes, for example, vector processors, coprocessors, graphics processing units (GPUs), general-purpose GPUs (GPGPUs), non-scalar processors, highly parallel processors, artificial intelligence (AI) processors, inference engines, machine-learning processors, other multithreaded processing units, scalar processors, serial processors, programmable logic devices (simple programmable logic devices, complex programmable logic devices, field programmable gate arrays (FPGAs), or any combination thereof. AU 112 is configured to render a set of rendered frames 118 each representing respective scenes within a screen space (e.g., the space in which a scene is displayed) according to one or more applications 110 for presentation on a display 134. As an example, AU 112 renders graphics objects (e.g., sets of primitives) for a scene to be displayed so as to produce pixel values representing a rendered frame 118. AU 112 then provides the rendered frame 118 (e.g., pixel values) to display 134. These pixel values, for example, include color values (YUV color values, RGB color values), depth values (z-values), or both. After receiving the rendered frame 118, display 134 uses the pixel values of the rendered frame 118 to display the scene including the rendered graphics objects. In some embodiments, display 134 is configured to display a rendered frame 118 (e.g., the pixel values of the rendered frame 118) according to a predetermined refresh rate of display 134. For example, in some embodiments, display 134 switches from displaying a first rendered frame 118 to a second rendered frame 118 based on the refresh rate of display 134.

To render the graphics objects, AU 112 implements processor cores 114-1 to 114-N that execute instructions concurrently or in parallel. For example, AU 112 executes instructions, operations, or both from a graphics pipeline 116 using processor cores 114 to render one or more graphics objects. A graphics pipeline 116 includes, for example, one or more steps, stages, or instructions to be performed by AU 112 in order to render one or more graphics objects for a scene. As an example, a graphics pipeline 116 includes data indicating an input assembler stage, vertex shader stage, hull shader stage, tessellator stage, domain shader stage, geometry shader stage, rasterizer stage, pixel shader stage, output merger stage, or any combination thereof to be performed by one or more processor cores 114 of AU 112 in order to render one or more graphics objects for a scene to be displayed.

In embodiments, one or more processor cores 114 of AU 112 each operate as a compute unit configured to perform one or more operations for one or more instructions received by AU 112. These compute units each include one or more single instruction, multiple data (SIMD) units that perform the same operation on different data sets to produce one or more results. For example, AU 112 includes one or more processor cores 114 each functioning as a compute unit that includes one or more SIMD units to perform operations for one or more instructions from a graphics pipeline 116. In some embodiments, one or more compute units (e.g., processor cores 114 functioning as one or more compute units) each include sets of SIMD units configured to execute the same operation for one or more threads (e.g., sequences of instructions) of a graphics pipeline 116. That is to say, some compute units include one or more wavefronts (e.g., groups of SIMD units) configured to execute the same operations for a thread block (e.g., a wave). Though the example implementation illustrated in FIG. 1 presents AU 112 as having three processor cores (114-1, 114-2, 114-N) representing an N number of cores, the number of processor cores 114 implemented in AU 112 is a matter of design choice. As such, in other implementations, AU 112 can include any number of processor cores 114. Some implementations of AU 112 are used for general-purpose computing. For example, in embodiments, AU 112 is configured to receive one or more instructions, such as program code 108, from one or more applications 110 that indicate operations associated with one or more video tasks, physical simulation tasks, computational tasks, fluid dynamics tasks, or any combination thereof, to name a few. In response to receiving the program code 108, AU 112 executes the instructions for the video tasks, physical simulation tasks, computational tasks, and fluid dynamics tasks. AU 112 then stores information in the memory 106 such as the results of the executed instructions.

To facilitate the performance of operations by the compute units for these waves, AU 112 includes one or more command processors (not shown for clarity). Such command processors, for example, include circuitry configured to execute one or more instructions of a wave by providing data indicating one or more operations, operands, instructions, variables, register files, or any combination thereof to one or more groups of SIMD units (e.g., wavefronts). According to some embodiments, a command processor of AU 112 is configured to provide data indicating one or more operations, operands, instructions, variables, register files, or any combination thereof to one or more groups of SIMD units sequentially. For example, the command processor provides data (e.g., one or more operations, operands, instructions, variables, register files) for a first wave to a group of SIMD units and provides data for a second wave to a group of SIMD units only after the first wave has finished executing. In other embodiments, one or more command processors of AU 112 are to provide data for two or more waves to a group of SIMD units asynchronously. That is to say, AU 112 includes one or more asynchronous command processors configured to provide data for two or more waves concurrently to a group of SIMD units such that the group of SIMD units concurrently executes at least a portion of each wave. For example, an asynchronous command processor is configured to first provide data for a first wave to a group of SIMD units such that the group of SIMD units executes the first wave. Additionally, based on the number of available SIMD units in the group of SIMD units not performing operations for the first wave, the asynchronous command processor is configured to provide data for at least a portion second of a second wave to the same group of SIMD units such that the same group of SIMD units executes at least a portion of the second wave concurrently with executing the first wave. In this way, one or more compute units of AU 112 are configured to concurrently execute instructions from two or more pipelines (e.g., graphics pipelines 116), two or more sections of a pipeline, or both.

In embodiments, AU 112 is configured to render the set of rendered frames 118 at a framerate based on, for example, an application 110 being executed by processing system 100. For example, AU 112 executes instructions from the application 110 such that AU 112 renders the set of rendered frames 118 at a framerate indicated by the instructions. Further, according to some embodiments, after rending a frame of a set of rendered frames 118, AU 112 is configured to render a user interface (e.g., UI) within the frame, such as a heads-up display, before the frame is displayed on, for example, display 134. To improve the framerate of the set of rendered frames 118 when the rendered frames 118 are displayed on display 134, AU 112 is configured to generate one or more interpolated frames 122 and insert respective interpolated frames 122 between corresponding rendered frames 118. Such interpolated frames 122, for example, include frames representing a scene that is temporally between, spatially between, or both temporally between and spacially between a first rendered frame of the set of rendered frames 118 and a second frame of the set of rendered frames 118. For example, an interpolated frame 122 represents a scene temporally between, spatially between, or both temporally between and spatially between a current frame of the set of rendered frames 118 and a previous frame of the set of rendered frames 118 (e.g., the frame immediately preceding the current frame in the set of rendered frames 118).

To generate one or more interpolated frames 122, in embodiments, AU 112 includes post-processing circuitry 120. Post-processing circuitry 120, for example, is configured to generate an interpolated frame 122 representing a scene temporally between, spatially between, or both temporally between and spacially between a first frame (e.g., current frame) of the set of rendered frames 118 and a second frame (e.g., immediately preceding frame) of the set of rendered frames based on the color values of the first and second frames and the depth values of the first and second frames. For example, based on the color values of the first and second frames and the depth values of the first and second frames, post-processing circuitry 120 generates one or more motion vectors 124. A motion vector 124, for example, represents the movement of one or more graphics objects from a first frame (e.g., previous frame) and a second frame (e.g., current frame). As an example, a motion vector 124 represents the movement of one or more pixels from a first position in a first frame to a second position in a second frame. To generate such motion vectors 124, post-processing circuitry 120 is configured to implement one or more motion estimation techniques, for example, block-matching algorithms, phase correlation methods, pixel recursive algorithms, optical flow methods, or any combination thereof, to name a few.

Once determining one or more motion vectors 124, post-processing circuitry 120 then uses the motion vectors 124, the color values of the first and second rendered frames 118, and the depth values of the first and second rendered frames 118 to determine an interpolated frame 122 representing a scene temporally between, spatially between, or both temporally between and spatially between the first frame and the second frame. For example, based on the motion vectors 124, the color values of the first and second rendered frames 118, and the depth values of the first and second rendered frames 118, post-processing circuitry 120 is configured to synthesize pixel values (e.g., color values and depth values) for each pixel of an interpolated frame 122. To this end, in embodiments, post-processing circuitry 120 implements one or more machine machine-learning models, neural networks (e.g., artificial neural networks, convolution neural networks, recurrent neural networks), or both configured to output pixel values for each pixel of an interpolated frame 122 based on receiving the motion vectors 124, the color values of the first and second rendered frames 118, the depth values of the first and second rendered frames 118, or any combination thereof as inputs. For example, in some embodiments, post-processing circuitry 120 is configured to implement a depth-aware frame interpolation neural network to synthesize pixel values for an interpolated frame 122. After generating the pixel values of the interpolated frame 122, post-processing circuitry 120, in some embodiments, then renders a UI within the interpolated frame 122 and inserts the interpolated frame 122 into the set of rendered frames 118. For example, post-processing circuitry 120 inserts the interpolated frame 122 between the first rendered frame and the second rendered frame within the set of rendered frames 118. AU 112 then provides the set of rendered frames 118 with one or more interpolated frames 122 to display 134. In response to receiving the set of rendered frames 118 with one or more interpolated frames 122, display 134 displays each rendered frame and interpolated frame 122 of the set of rendered frames 118 such that the displayed frames have a greater framerate when compared to a set of rendered frames 118 without any interpolated frames 122. That is to say, because inserting the interpolated frames 122 into the set of rendered frames 118 increases the number of frames in the set of rendered frames 118, the framerate of the set of rendered frames 118 when displayed is increased to a predetermined target framerate.

However, certain conditions arise when rendering the set of rendered frames 118 and generating the interpolated frames 122 that cause one or more interpolated frames 122 to be displayed at a different framerate from the target framerate (e.g., the increased framerate of the set of rendered frames 118), the refresh rate of display 134, or both. For example, delays in rendering one or more rendered frames of the set of rendered frames 118, delays in generating one or more interpolated frames 122, or both increase the likelihood that one or more interpolated frames 122 are presented at a different framerate than the target framerate, the refresh rate of display 134, or both. Presenting one or more interpolated frames 122 at a different framerate than the target framerate, the refresh rate of display 134, or both increases the likelihood of introducing visual distortions when the interpolated frames 122 are displayed such as screen tears, blurred objects, and the like. To help ensure that the interpolated frames 122 are presented at the same framerate as the target framerate, the refresh rate of display 134, or both, AU 112 includes timing circuitry 126. Timing circuitry 126, for example, is configured to determine a corresponding timing at which to display one or more generated interpolated frames 122 such that the interpolates frames 122 are presented at the same framerate as the target framerate, the refresh rate of display 134, or both. Such timings at which to display one or more generated interpolated frames 122 are presented in FIG. 1 as interpolated frame timings 130. Each interpolated frame timing 130, for example, represents a certain time at which to display a corresponding interpolated frame 122, an amount of time after a rendered frame 118 has been presented, an amount of time after a previous interpolated frame 122 has been presented, or any combination thereof.

To determine a corresponding interpolated frame timing 130 for one or more interpolated frames 122, timing circuitry 126 is configured to track one or more rendering metrics 128 while one or more rendered frames are rendered, one or more interpolated frames 122 are generated, or both. Such rendering metrics 128, for example, include timing information indicating respective rendering times for one or more rendered frames (e.g., how long the rendered frame took to render), respective UI rendering times for one or more rendered frames (e.g., how long the UI took to render in a rendered frame), respective presentation times for one or more rendered frames (e.g., how long a rendered frame was presented on display 134), a refresh rate of display 134, respective generation times for one or more interpolated frames 122 (e.g., how long the interpolated frame 122 took to generate), respective UI rendering times for one or more interpolated frames 122 (e.g., how long the UI took to render in an interpolated frame 122), respective presentation times for one or more interpolated frames 122 (e.g., how long an interpolated frame 122 was presented on display 134), or any combination thereof. In embodiments, timing circuitry 126 is configured to determine one or more rendering metrics 128 by, for example, monitoring when data representing a frame (e.g., rendered frame, interpolated frame 122) is stored in a buffer (e.g., frame buffer, color buffer, depth buffer, stencil buffer), monitoring when data representing a frame is output from a buffer, monitoring the number of cycles to render a rendered frame 118, monitoring the number of cycles to generate an interpolated frame 122, monitoring the number of cycles to generate a UI within a frame, or any combination thereof, to name a few.

According to embodiments, timing circuitry 126 is configured to determine a respective interpolated frame timing 130 for a corresponding interpolated frame 122 based on rendering metrics 128. As an example, in some embodiments, timing circuitry 126 first determines one or more rendering metrics 128 associated with an interpolated frame 122 to be displayed. Such rendering metrics 128 associated with the interpolated frame 122 include, for example, the rendering times of one or more rendered frames used to generate the interpolated frame 122, the UI rendering times of one or more rendered frames used to generate the interpolated frame 122, the presentation time of one or more rendered frames used to generate the interpolated frame 122, the UI rendering time for the interpolated frame 122, the generation time of the interpolated frame, the refresh rate of display 134, or any combination thereof. In some embodiments, after determining one or more rendering metrics 128 associated with an interpolated frame 122 to be displayed, timing circuitry 126 is configured to compare the determined rendering metrics 128 to one or more threshold values. These threshold values, for example, each represent predetermined values each representing a threshold time or threshold rate. Based on a comparison of a determined rendering metric 128 to a threshold value indicating a delay in the presentation of the interpolated frame 122 (e.g., indicating that the interpolated frame 122 will be presented at a different framerate than the target framerate, the refresh rate of display 134, or both), timing circuitry 126 then determines an interpolated frame timing 130 for the interpolated frame 122. As an example, based on one or more determined rendering metrics 128 being equal to or exceeding one or more threshold values, timing circuitry 126 determines a delay in the display of the interpolated frame 122. After determining such a delay in the display of the interpolated frame 122, timing circuitry 126 determines an interpolated frame timing 130 for the interpolated frame 122.

According to embodiments, timing circuitry 126 is configured to determine an interpolated frame timing 130 for an interpolated frame 122 based on one or more determined rendering metrics 128 associated with the interpolated frame 122. For example, timing circuitry 126 first determines the length of the delay in presenting the interpolated frame 122. The length of the delay in presenting the interpolated frame 122, for example, represents a difference between the time the interpolated frame 122 is expected to be presented based on the target framerate, refresh rate of display 134, or both and the time the interpolated frame 122 will actually be displayed as indicated by the rendering metrics 128 associated with the interpolated frame 122. To determine the length of a delay in presenting the interpolated frame 122, timing circuitry 126 is configured to aggregate one or more rendering metrics 128 associated with the interpolated frame 122, take the average of one or more rendering metrics 128 associated with the interpolated frame, compare the one or more rendering metrics associated with the interpolated frame 122 to one or more predetermined threshold values, compare the one or more rendering metrics associated with the interpolated frame 122 to the target framerate, compare the one or more rendering metrics associated with the interpolated frame 122 to the refresh rate of display 134, or any combination thereof. As an example, timing circuitry 126 first combines the rendering times of the rendered frames 118 used to generate the interpolated frame 122, the generation time of the interpolated frame 122, the presentation time of a rendered frames 118 used to generate the interpolated frame 122, and the UI rendering times for the rendered frames 118 used to generate the interpolated frame 122 and for the interpolated frame 122. Timing circuitry 126 then compares this combination of rendering metrics 128 to one or more predetermined values to determine the length of the delay in presenting the interpolated frame 122.

Based on the determined length of the delay in presenting the interpolated frame 122, timing circuitry 126 determines a corresponding interpolated frame timing 130 for the interpolated frame 122. For example, timing circuitry 126 compares the length of the delay in presenting the interpolated frame 122 to the target framerate, refresh rate of display 134, or both to determine an interpolated frame timing 130 for the interpolated frame 122. That is to say, based on a comparison of the length of the delay to the target framerate, refresh rate of display 134, or both, timing circuitry 126 determines a time at which to present the interpolated frame 122 such that interpolated frame 122 is presented in accordance with the target framerate, refresh rate of display 134, or both. As an example, based on a comparison of the length of the delay to the target framerate, refresh rate of display 134, or both, timing circuitry 126 determines a time after a rendered frame 118 has been displayed at which to present the interpolated frame 122 such that interpolated frame 122 is presented in accordance with the target framerate, refresh rate of display 134, or both. Because timing circuitry 126 is configured to determine a corresponding interpolated frame timing 130 for an interpolated frame 122 such that interpolated frame 122 is presented in accordance with the target framerate, refresh rate of display 134, or both, the likelihood that the presentation of the interpolated frame 122 introduces a visual distortion (e.g., screen tear, blurred object) is reduced. In this way, processing system 100 is enabled to increase the framerate of a set of rendered frames 118 to a target framerate by generating and displaying one or more interpolated frames 122 while also reducing the likelihood that presenting such interpolated frames 122 introduces visual distortions.

In some embodiments, timing circuitry 126 is configured to determine the length of one or more delays in the presentation of an interpolated frame 122, one or more interpolated frame timings 130, or both by implementing one or more trained machine-learning models, neural networks, or both. As an example, to determine the length of a delay in presenting an interpolated frame 122, timing circuitry 126 includes one or more trained machine-learning models, neural networks, or both configured to receive one or more rendering metrics 128 associated with an interpolated frame 122 as inputs and output a length of a delay in presenting the interpolated frame 122. As another example, to determine an interpolated frame timing 130 for an interpolated frame 122, timing circuitry 126 includes one or more trained machine-learning models, neural networks, or both configured to receive a length of a delay associated with the interpolated frame 122, one or more rendering metrics 128 associated with the interpolated frame 122, or both as inputs and output an interpolated frame timing 130 for the interpolated frame 122.

Further, according to some embodiments, timing circuitry 126 is configured to determine one or more rendering metrics 128, determine one or more lengths of delays in presenting interpolated frames 122, determine one or more interpolated frame timings 130, or any combination thereof concurrently with AU 112 rendering one or more rendered frames 118. For example, in embodiments, one or more applications 110 include instructions that, when executed by AU 112, cause timing circuitry 126 to determine one or more rendering metrics 128, determine one or more delays in presenting interpolated frames 122, determine one or more interpolated frame timings 130, or any combination thereof. Further, in such embodiments, AU 112 includes one or more asynchronous command processors configured to concurrently execute instructions from graphics pipeline 116 and instructions to cause timing circuitry 126 to determine one or more rendering metrics 128, determine one or more delays in presenting interpolated frames 122, determine one or more interpolated frame timings 130, or any combination thereof using one or more groups of SIMD units (e.g., wavefronts). For example, such an asynchronous processor is configured to concurrently send data (e.g., one or more operations, operands, instructions, variables, register files) of a first wave associated with graphics pipeline 116 to a first group of SIMD units and data of at least a portion of a second wave associated with a timing operation (e.g., determine one or more rendering metrics 128, determine one or more delays in presenting interpolated frames 122, determine one or more interpolated frame timings 130) to the same group of SIMD units. In this way, the same group of SIMD units concurrently executes a first wave associated with a graphics pipeline 116 and at least a portion of a second wave associated with a timing operation, which helps improve the processing efficiency of processing system 100.

In some embodiments, processing system 100 includes input/output (I/O) engine 132 that includes circuitry to handle input or output operations associated with display 134, as well as other elements of the processing system 100 such as keyboards, mice, printers, external disks, and the like. The I/O engine 132 is coupled to the bus 136 so that the I/O engine 132 communicates with the memory 106, AU 112, or the central processing unit (CPU) 102.

In embodiments, processing system 100 also includes CPU 102 that is connected to the bus 136 and therefore communicates with AU 112 and the memory 106 via the bus 136. CPU 102 implements a plurality of processor cores 104-1 to 104-M that execute instructions concurrently or in parallel. In implementations, one or more of the processor cores 104 operate as SIMD units that perform the same operation on different data sets. Though in the example implementation illustrated in FIG. 1, three processor cores (104-1, 104-2, 104-M) are presented representing an M number of cores, the number of processor cores 104 implemented in CPU 102 is a matter of design choice. As such, in other implementations, CPU 102 can include any number of processor cores 104. In some implementations, CPU 102 and AU 112 have an equal number of processor cores 104, 114 while in other implementations, CPU 102 and AU 112 have a different number of processor cores 104, 114. The processor cores 104 of CPU 102 are configured to execute instructions such as program code 108 for one or more applications 110 (e.g., graphics applications, compute applications, machine-learning applications) stored in the memory 106, and CPU 102 stores information in the memory 106 such as the results of the executed instructions. CPU 102 is also able to initiate graphics processing by issuing draw calls to AU 112.

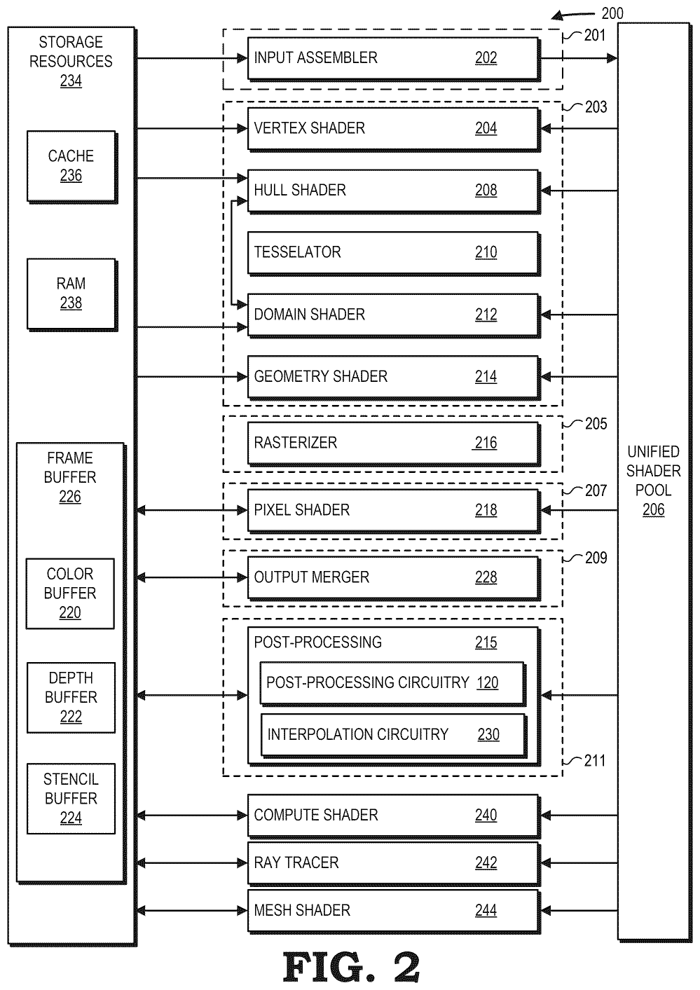

Referring now to FIG. 2, a block diagram of an example graphics pipeline 200 is presented, in accordance with some embodiments. In embodiments, example graphics pipeline 200 is implemented in processing system 100 as graphics pipeline 116. In embodiments, example graphics pipeline 200 is configured to render graphics objects as images that depict a scene which has three-dimensional geometry in virtual space (also referred to herein as “screen space”), but potentially a two-dimensional geometry. Example graphics pipeline 200 typically receives a representation of a three-dimensional scene, processes the representation, and outputs a two-dimensional raster image. These stages of example graphics pipeline 200 process data that is initially properties at end points (or vertices) of a geometric primitive, where the primitive provides information on an object being rendered. Typical primitives in three-dimensional graphics include triangles and lines, where the vertices of these geometric primitives provide information on, for example, x-y-z coordinates, texture, and reflectivity.

According to embodiments, example graphics pipeline 200 has access to storage resources 234 (also referred to herein as “storage components”). Storage resources 234 include, for example, a hierarchy of one or more memories or caches that are used to implement buffers and store vertex data, texture data, and the like for example graphics pipeline 200. In some embodiments, storage resources 234 are implemented within processing system 100 using respective portions of system memory 106. In embodiments, storage resources 234 include or otherwise have access to one or more caches 236, one or more random access memory (RAM) units 238, video random access memory unit(s) (not pictured for clarity), one or more processor registers (not pictured for clarity), and the like, depending on the nature of data at the particular stage of example graphics pipeline 200. Accordingly, it is understood that storage resources 234 refer to any processor-accessible memory utilized in the implementation of example graphics pipeline 200.

Example graphics pipeline 200, for example, includes stages that each perform respective functionalities. For example, these stages represent subdivisions of functionality of example graphics pipeline 200. Each stage is implemented partially or fully as shader programs executed by AU 112. According to embodiments, stages 201 and 203 of example graphics pipeline 200 represent the front-end geometry processing portion of example graphics pipeline 200 prior to rasterization. Stages 205 to 211 represent the back-end pixel processing portion of example graphics pipeline 200.

During input assembler stage 201 of example graphics pipeline 200, an input assembler 202 is configured to access information from the storage resources 234 that is used to define objects that represent portions of a model of a scene. For example, in various embodiments, the input assembler 202 includes circuitry configured to read primitive data (e.g., points, lines and/or triangles) from user-filled buffers (e.g., buffers filled at the request of software executed by processing system 100, such as an application 110) and assembles the data into primitives that will be used by other pipeline stages of the example graphics pipeline 200. “User,” as used herein, refers to an application 110 or other entity that provides shader code and three-dimensional objects for rendering to example graphics pipeline 200. In embodiments, the input assembler 202 is configured to assemble vertices into several different primitive types (e.g., line lists, triangle strips, primitives with adjacency) based on the primitive data included in the user-filled buffers and formats the assembled primitives for use by the rest of example graphics pipeline 200.

According to embodiments, example graphics pipeline 200 operates on one or more virtual objects defined by a set of vertices set up in the screen space and having geometry that is defined with respect to coordinates in the scene. For example, the input data utilized in example graphics pipeline 200 includes a polygon mesh model of the scene geometry whose vertices correspond to the primitives processed in the rendering pipeline in accordance with aspects of the present disclosure, and the initial vertex geometry is set up in the storage resources 234 during an application stage implemented by, for example, CPU 102.

During the vertex processing stage 203 of example graphics pipeline 200, one or more vertex shaders 204 are configured to process vertexes of the primitives assembled by the input assembler 202. For example, a vertex shader 204 includes circuitry configured to first receive a single vertex of a primitive as an input and output a single vertex. The vertex shader 204 then performs various per-vertex operations such as transformations, skinning, morphing, per-vertex lighting, or any combination thereof, to name a few. Transformation operations include various operations to transform the coordinates (e.g., X-Y coordinate, Z-depth values) of the vertices. These operations include, for example, one or more modeling transformations, viewing transformations, projection transformations, perspective division, viewport transformations, or any combination thereof. Herein, such transformations are considered to modify the coordinates or “position” of the vertices on which the transforms are performed. Other operations of the vertex shader 204 modify attributes other than the coordinates.

In embodiments, one or more vertex shaders 204 are implemented partially or fully as vertex shader programs to be executed on one or more processor cores 114 (e.g., one or more processor cores 114 operating as compute units). Some embodiments of shaders such as the vertex shader 204 implement massive single-instruction-multiple-data (SIMD) processing so that multiple vertices are processed concurrently. In at least some embodiments, example graphics pipeline 200 implements a unified shader model so that all the shaders included in example graphics pipeline 200 have the same execution platform on the shared massive SIMD units of the processor cores 114. In such embodiments, the shaders, including one or more vertex shaders 204, are implemented using a common set of resources that is referred to herein as the unified shader pool 206.

During the vertex processing stage 203, in some embodiments, one or more vertex shaders 204 perform additional vertex processing computations that subdivide primitives and generate new vertices and new geometries in the screen space. These additional vertex processing computations, for example, are performed by one or more of a hull shader 208, a tessellator 210, a domain shader 212, and a geometry shader 214. The hull shader 208, for example, includes circuitry configured to operate on input high-order patches or control points that are used to define the input patches. Additionally, the hull shader 208 outputs tessellation factors and other patch data. According to embodiments, within example graphics pipeline 200, primitives generated by the hull shader 208 are provided to the tessellator 210. The tessellator 210 includes circuitry configured to receive objects (such as patches) from the hull shader 208 and generate information identifying primitives corresponding to the input object, for example, by tessellating the input objects based on tessellation factors provided to the tessellator 210 by the hull shader 208. Tessellation, as an example, subdivides input higher-order primitives such as patches into a set of lower-order output primitives that represent finer levels of detail (e.g., as indicated by tessellation factors that specify the granularity of the primitives produced by the tessellation process). As such, a model of a scene is represented by a smaller number of higher-order primitives (e.g., to save memory or bandwidth) and additional details are added by tessellating the higher-order primitive.

The domain shader 212 includes circuitry configured to receive a domain location, other patch data, or both as inputs. The domain shader 212 is configured to operate on the provided information and generate a single vertex for output based on the input domain location and other information. The geometry shader 214 includes circuitry configured to receive a primitive as an input and generate up to four primitives based on the input primitive. In some embodiments, the geometry shader 214 retrieves vertex data from storage resources 234 and generates new graphics primitives, such as lines and triangles, from the vertex data in storage resources 234. In particular, the geometry shader 214 retrieves vertex data for a primitive and generates one or more primitives. To this end, for example, the geometry shader 214 is configured to operate on a triangle primitive with three vertices. A variety of different types of operations can be performed by the geometry shader 214, including operations such as point sprint expansion, dynamic particle system operations, fur-fin generation, shadow volume generation, single pass render-to-cubemap, per-primitive material swapping, per-primitive material setup, or any combination thereof. According to embodiments, the hull shader 208, the domain shader 212, the geometry shader 214, or any combination thereof are implemented as shader programs to be executed on the processor cores 114, whereas the tessellator 210, for example, is implemented by fixed-function hardware.

Once front-end processing (e.g., stages 201, 203) of example graphics pipeline 200 is complete, the scene is defined by a set of vertices which each have a set of vertex parameter values stored in the storage resources 234. In certain implementations, the vertex parameter values output from the vertex processing stage 203 includes positions defined with different homogeneous coordinates for different zones.

As described above, stages 205 to 211 represent the back-end processing of example graphics pipeline 200. The rasterizer stage 205 includes a rasterizer 216 having circuitry configured to accept and rasterize simple primitives that are generated upstream. The rasterizer 216 is configured to perform shading operations and other operations such as clipping, perspective dividing, scissoring, viewport selection, and the like. In embodiments, the rasterizer 216 is configured to generate a set of pixels that are subsequently processed in the pixel processing/shader stage 207 of the example graphics processing pipeline. In some implementations, the set of pixels includes one or more tiles. In one or more embodiments, the rasterizer 216 is implemented by fixed-function hardware.

The pixel processing stage 207 of example graphics pipeline 200 includes one or more pixel shaders 218 that include circuitry configured to receive a pixel flow (e.g., the set of pixels generated by the rasterizer 216) as an input and output another pixel flow based on the input pixel flow. To this end, a pixel shader 218 is configured to calculate pixel values for screen pixels based on the primitives generated upstream and the results of rasterization. In embodiments, the pixel shader 218 is configured to apply textures from a texture memory, which, according to some embodiments, is implemented as part of the storage resources 234. The pixel values generated by one or more pixel shaders 218 include, for example, color values, depth values, and stencil values, and are stored in one or more corresponding buffers, for example, a color buffer 220, a depth buffer 222, and a stencil buffer 224, respectively. The combination of the color buffer 220, the depth buffer 222, the stencil buffer 224, or any combination thereof is referred to as a frame buffer 226. In some embodiments, example graphics pipeline 200 implements multiple frame buffers 226 including front buffers, back buffers and intermediate buffers such as render targets, frame buffer objects, and the like. Operations for the pixel shader 218 are performed by a shader program that executes on the processor cores 114.

According to embodiments, the pixel shader 218, or another shader, accesses shader data, such as texture data, stored in the storage resources 234. Such texture data defines textures which represent bitmap images used at various points in example graphics pipeline 200. For example, the pixel shader 218 is configured to apply textures to pixels to improve apparent rendering complexity (e.g., to provide a more “photorealistic” look) without increasing the number of vertices to be rendered. In another instance, the vertex shader 204 uses texture data to modify primitives to increase complexity, by, for example, creating or modifying vertices for improved aesthetics. AS an example, the vertex shader 204 uses a height map stored in storage resources 234 to modify displacement of vertices. This type of technique can be used, for example, to generate more realistic-looking water as compared with textures only being used in the pixel processing stage 207, by modifying the position and number of vertices used to render the water. The geometry shader 214, in some embodiments, also accesses texture data from the storage resources 234.

Within example graphics pipeline 200, the output merger stage 209 includes an output merger 228 accepting outputs from the pixel processing stage 207 and merges these outputs. As an example, in embodiments, output merger 228 includes circuitry configured to perform operations such as z-testing, alpha blending, stenciling, or any combination thereof on the pixel values of each pixel received from the pixel shader 218 to determine the final color for a screen pixel. For example, the output merger 228 combines various types of data (e.g., pixel values, depth values, stencil information) with the contents of the color buffer 220, depth buffer 222, and, in some embodiments, the stencil buffer 224 and stores the combined output back into the frame buffer 226. The output of the output merger stage 209 can be referred to as rendered pixels that collectively form a rendered frame 118. In one or more implementations, the output merger 228 is implemented by fixed-function hardware.

In embodiments, example graphics pipeline 200 includes a post-processing stage 211 implemented after the output merger stage 209. During the post-processing stage 211, post-processing circuitry 120 operates on the rendered frame stored (or individual pixels) stored in the frame buffer 226 to apply one or more post-processing effects, such as ambient occlusion or tonemapping, prior to the frame being output to the display. Further, according to some embodiments, post-processing stage 211 includes post-processing circuitry 120 rendering a UI, such as a head-up display, within a rendered frame stored in frame buffer 226. For example, at post-processing stage 211, post-processing circuitry 120 renders one or more graphic objects within the rendered frame so as to add a UI within the rendered frame stored in frame buffer 226. After adding the UI to the rendered frame, the post-processed frame is written to a frame buffer 226, such as a back buffer for display or an intermediate buffer for further post-processing. The example graphics pipeline 200, in some embodiments, includes other shaders or components, such as a computer shader 240, a ray tracer 242, a mesh shader 244, and the like, which are configured to communicate with one or more of the other components of example graphics pipeline 200.

In embodiments, to help improve the framerate of a set of rendered frames 118 rendered by the example graphics pipeline 200, post-processing stage 215 includes interpolation circuitry 230 generating one or more interpolated frames 122. Interpolation circuitry 230, according to some embodiments, is implemented within or otherwise connected to post-processing circuitry 120. To generate an interpolated frame 122, interpolation circuitry 230 is configured to generate one or more motion vectors 124 based on two or more rendered frames 118. For example, interpolation circuitry 230 first retrieves pixel data (e.g., color values, depth values) of a first rendered frame (e.g., current frame) from respective color buffers 220 and depth buffers 222 associated with the first rendered frame. Further, interpolation circuitry 230 retrieves pixel data of a second rendered frame (e.g., previous frame) from respective color buffers 220 and depth buffers 222 associated with the second rendered frame. In embodiments, the second rendered frame is the frame within a set of rendered frames 118 immediately preceding the first frame. Interpolation circuitry 230 then implements one or more motion estimation techniques based on the pixel values associated with the first rendered frame and the pixel values associated with the second rendered frame to output one or more motion vectors 124. Based on one or of the determined motion vectors 124, interpolation circuitry 230 is configured to generate pixel values (e.g., color values, depth values, stencil values) for an interpolated frame 122 that represents a scene temporally between, spatially between, or both temporally between and spatially between the first rendered frame and the second rendered frame. As an example, interpolation circuitry 230 is configured to generate pixel values for an interpolated frame 122 that represents a viewpoint of the scene that is temporally between, spatially between, or both temporally between and spatially between the viewpoints of the first rendered frame and the second rendered frame. After generating the pixel values for the interpolated frame 122, interpolation circuitry 230 stores the pixel values in respective color buffers 220, depth buffers 222, and stencil buffers 224. According to some embodiments, post-processing circuitry 120 is configured to render a UI within the interpolated frame 122 stored in color buffers 220, depth buffers 222, and stencil buffers 224 (e.g., stored in frame buffer 226). To this end, post-processing circuitry 120 renders one or more graphic objects within the interpolated frame 122 so as to add a UI within the interpolated frame 122 stored in frame buffer 226.

In embodiments, timing circuitry 126 is configured to determine a respective interpolated frame timing 130 for the interpolated frame 122 stored in frame buffer 226 concurrently with AU 112 performing instructions for one or more stages 201 to 211 of example graphics pipeline 200. To this end, in embodiments, timing circuitry 126 is configured to determine one or more rendering metrics 128 concurrently with AU 112 performing instructions for one or more stages 201 to 211 of example graphics pipeline 200. As an example, timing circuitry 126 determines the time (e.g., rendering time) it took to render each rendered frame 118 used to generate an interpolated frame 122. That is to say, timing circuitry 126 determines the time (e.g., number of cycles) it took AU 112 to perform instructions from stages 201 to 211 of example graphics pipeline 200 so as to render the rendered frames 118 used to generate the interpolated frame 122. As another example, timing circuitry determines the time (e.g., UI rendering time) it took post-processing circuitry 120 to render a UI in the rendered frames 118 used to generate the interpolated frame 122, render the UI in the interpolated frame 122, or both. As yet another example, timing circuitry 126 determines the time it took interpolation circuitry 230 to generate the interpolated frame 122.

After timing circuitry 126 has determined one or more rendering metrics 128 associated with the interpolated frame 122 stored in frame buffer 226, timing circuitry 126 determines a corresponding interpolated frame timing 130 based on the determined rendering metrics 128. To this end, timing circuitry 126 determines a length of a delay in presenting the interpolated frame 122 stored in frame buffer 226 based on the determined rendering metrics 128 associated with the interpolated frame 122. For example, timing circuitry 126 first combines the time it took to render the rendered frames 118 used to generate the interpolated frame 122, the time it took to generate the interpolated frame 122, the time it took to render a UI in the rendered frames 118 used to generate the interpolated frame 122, and the time it took to render a UI in the interpolated frame 122. Timing circuitry 126 then compares this combination of rendering metrics 128 to one or more predetermined values to determine the length of a delay in presenting the interpolated frame 122. Based on the determined length of the delay in presenting the interpolated frame 122, timing circuitry 126 determines a corresponding interpolated frame timing 130 for the interpolated frame 122 stored in frame buffer 226. For example, timing circuitry 126 compares the length of the delay in presenting the interpolated frame 122 to the target framerate, refresh rate of display 134, or both to determine an interpolated frame timing 130 for the interpolated frame 122 stored in frame buffer 226.

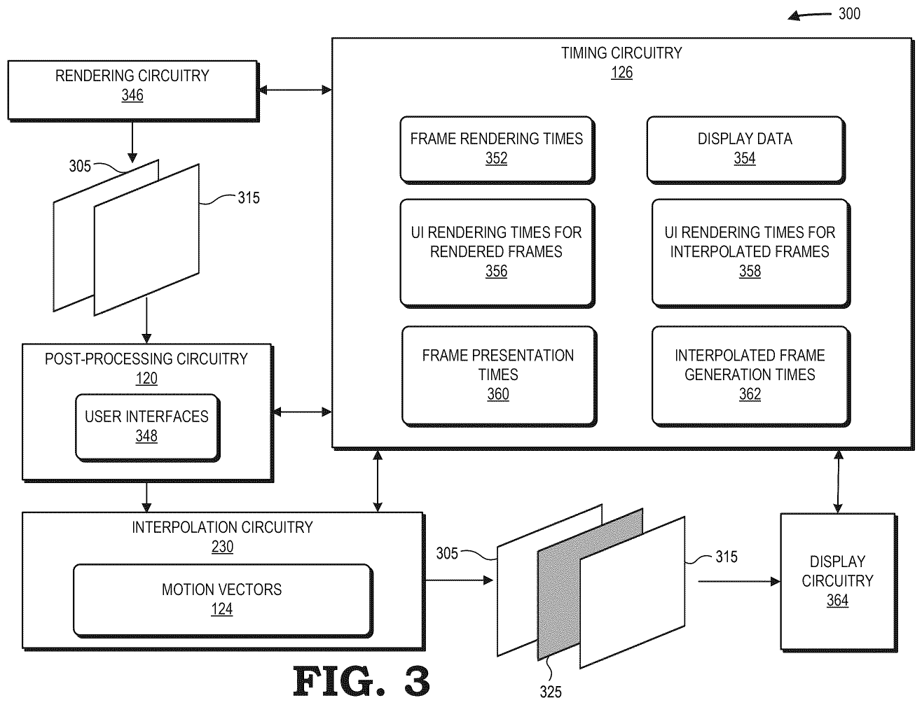

Referring now to FIG. 3, an example operation 300 for determining timing data for the presentation of interpolated frames is presented, in accordance with some embodiments. In embodiments, example operation 300 is implemented in processing system 100 by AU 112, timing circuitry 126, or both. According to embodiments, example operation 300 first includes rendering circuitry 346 rendering a first rendered frame 305 and a second rendered frame 315. For example, example operation 300 includes rendering circuitry 346 generating color data, depth data, stencil data, or any combination thereof for a first rendered frame 305 and a second rendered frame 315. Rendering circuitry 346, for example, is implemented as at least a portion of AU 112 (e.g., one or more processor cores 114) and is configured to render rendered frames according to stages 201 to 211 of example graphics pipeline 200. In embodiments, the first rendered frame 305 and the second rendered frame 315 are part of a set of rendered frames 118 and each represents a respective scene having a respective viewpoint. Further, in some embodiments, the first rendered frame 305 immediately precedes the second rendered frame 315 in the set of rendered frames 118 such that the first rendered frame 305 and second rendered frame 315 represent scenes that are temporally adjacent, spatially adjacent, or both temporally and spatially adjacent. After rendering rendered frames 305, 315, example operation 300 includes post-processing circuitry 120 rendering respective user interfaces (UIs) 348 in each rendered frame 305, 315. Such a UI 348, for example, includes one or more graphics objects that form an interface, such as a heads-up display, within a rendered frame 305, 315.

According to embodiments, example operation 300 also includes interpolation circuitry 230 generating one or more motion vectors 124 based on the pixel data (e.g., color values, depth values, stencil values) of the first rendered frame 305 and the second rendered frame 315. Such motion vectors 124, for example, represent the movement of one or more pixels from a first viewpoint represented by the first rendered frame 305 to the second viewpoint represented by the second rendered frame 315. To generate one or more motion vectors 124, interpolation circuitry 230 is configured to implement one or more motion estimation techniques using the pixel data of the first rendered frame 305 and the second rendered frame 315 as inputs. As an example, interpolation circuitry 230 implements block-matching algorithms, phase correlation methods, pixel recursive algorithms, optical flow methods, or any combination thereof using the pixel values of the first rendered frame 305 and the pixel values of the second rendered frame 315 as inputs to output one or more motion vectors 124. In some embodiments, after generating one or more motion vectors 124, interpolation circuitry 230 is configured to store the motion vectors 124 in one or more motion vector buffers. Such motion vector buffers, for example, use at least a portion of storage resources 234. Based on the motion vectors 124, interpolation circuitry 230 is configured to generate an interpolated frame 325 representing a scene with a respective viewpoint that is temporally between, spatially between, or both temporally and spatially between the first rendered frame 305 and the second rendered frame 315. To this end, interpolation circuitry 230 generates depth values and color values for an interpolated frame 325 based on motion vectors 124, the pixel data of the first rendered frame 305, and the pixel data of the second rendered frame 315. For example, interpolation circuitry 230 implements one or more machine machine-learning models, neural networks (e.g., artificial neural networks, convolution neural networks, recurrent neural networks), or both configured to output depth values and color values for an interpolated frame 325 based on the motion vectors 124, the pixel data of the first rendered frame 305, and the pixel data of the second rendered frame 315. In some embodiments, interpolation circuitry 230 is configured to implement a depth-aware frame interpolation neural network to the interpolated frame 325.

According to embodiments, the first rendered frame 305, the second rendered frame 315, and the interpolated frame 122 are displayed on, for example, display 134 according to display circuitry 364. Display circuitry 364, for example, is configured to control when frame data (e.g., data representing the first rendered frame 305, the second rendered frame 315, or the interpolated frame 325) is provided to display 134. As an example, display circuitry 364 is configured to provide frame data from the frame buffer to display 134, a buffer (e.g., display buffer), or both based on a framerate associated with the rendered frames (e.g., target framerate), refresh rate of display 134, or both. To this end, as an example, display circuitry provides data representing a frame (e.g., rendered frames 305, 315; interpolated frame 325) from frame buffer 226 to display 134, a buffer (e.g., display buffer), or both each time a predetermined amount of time associated with the target framerate, refresh rate of display 134, or both elapses. However, under certain conditions, display circuitry 364 provides data representing the interpolated frame 325 to display 134, a buffer (e.g., display buffer), or both such that the interpolated frame 325 is presented at a different framerate from the target framerate, refresh rate of display 134, or both. For example, delays in rendering rendered frame 305 and rendered frame 315, delays in generating the interpolated frame 325, or both increase the likelihood that the interpolated frame 325 is displayed at a different framerate from the target framerate, refresh rate of display 134, or both. Due to the interpolated frame 325 being presented at a different framerate from the target framerate, refresh rate of display 134, or both, the likelihood of introducing visual distortions is increased, which negatively impacts user experience.

To help ensure that the interpolated frame 325 is presented at a framerate compatible with the target framerate, refresh rate of display 134, or both, example operation 300 also includes timing circuitry 126 determining one or more rendering metrics 128 associated with the interpolated frame 325. For example, in embodiments, in example operation 300, timing circuitry 126 is configured to determine the frame rendering times 352 of the first rendered frame 305 and the second rendered frame 315. Such frame rendering times 352, for example, represent the time (e.g., in cycles) it took to render a certain frame. That is to say, the time needed to render a frame according to stages 201 to 211 of example graphic pipeline 200. To determine the frame rendering times 352 for rendered frame 305 and rendered frame 315, respectively, timing circuitry 126 is configured to monitor when an instruction to render the rendered frame 305 or rendered frame 315, respectively, begins execution; monitor when data representing the rendered frame 305 or rendered frame 315, respectively, is stored in frame buffer 226; monitor the number of cycles rendering circuitry 346 used to render the rendered frame 305 or rendered frame 315, respectively; or any combination thereof. Further, in embodiments, timing circuitry 126 is configured to determine the UI rendering times for rendered frames 356. A UI rendering time for rendered frames 356, for example, represents the time (e.g., in cycles) it took to render a UI 348 in a certain rendered frame. That is to say, the time needed to render a UI 348 in rendered frame 305 or rendered frame 315. To determine the UI rendering time for rendered frames 356 for rendered frame 305 and rendered frame 315, respectively, timing circuitry 126 is configured to monitor when post-processing circuitry 120 begins rendering a UI 348 in rendered frame 305 or rendered frame 315, respectively; monitor when data representing the rendered frame 305 or rendered frame 315, respectively, with a corresponding UI 348 is stored in frame buffer 226; monitor the number of cycles post-processing circuitry 120 used to render the UI 348 in rendered frame 305 or rendered frame 315, respectively; or any combination thereof.

Additionally, in some embodiments, timing circuitry 126 is configured to determine frame presentation times 360 for one or more rendered frames, interpolated frames, or both. For example, timing circuitry 126 is configured to determine frame presentation times 360 for one or more rendered frames, interpolated frames, or both that were displayed before interpolated frame 325. These frame presentation times 360, for example, represent how long respective rendered frames, interpolated frames, or both were displayed on display 134. To determine the frame presentation time 360 for a frame, timing circuitry 126 is configured to monitor when display circuitry 364 provides frame data to a display 134, monitor when frames begin to be displayed, monitor when a frame stops being displayed, or any combination thereof. According to embodiments, timing circuitry 126 is further configured to determine display data 354. Display data 354, for example, includes data associated with a display 134 such as the refresh rate of the display, maximum framerate of the display, settings of the display, or any combination thereof. To determine display data 354, timing circuitry 126 is configured to query a display 134, query one or more display drivers, or both. Further, timing circuitry 126 is configured to determine UI rendering times for interpolated frames 358. A UI rendering time for interpolated frames 358, for example, represents the time (e.g., in cycles) it took to render a UI 348 in a certain interpolated frame. To determine the UI rendering time for interpolated frames 358 for interpolated frame 325, timing circuitry 126 is configured to monitor when post-processing circuitry 120 begins rendering a UI 348 in interpolated frame 325, monitor when data representing the interpolated frame 325 with a corresponding UI 348 is stored in frame buffer 226, monitor the number of cycles post-processing circuitry 120 used to render the UI 348 in interpolated frame 325, or any combination thereof.

According to some embodiments, timing circuitry 126 is also configured to determine interpolated frame generation times 362 which represents the time it took to generate corresponding interpolated frames. For example, timing circuitry 126 is configured to determine an interpolated frame generation time 362 for interpolated frame 325. To determine an interpolated frame generation time 362 for interpolated frame 325, timing circuitry 126 is configured to monitor when interpolation circuitry 230 begins generating motion vectors 124, monitor when data representing the interpolated frame 325 is stored in frame buffer 226, monitor the number of cycles interpolation circuitry 230 used to generate the interpolated frame 325, or any combination thereof. After determining one or more frame rendering times 352, UI rendering times for rendered frames 356, frame presentation times 360, display data 354, UI rendering times for interpolated frames 358, interpolated frame generation times 362, or any combination thereof, timing circuitry 126 is configured to determine an interpolated frame timing 130 for the interpolated frame 325. As an example, timing circuitry 126 first determines the length of a delay in presenting interpolated frame 325 based on the determined one or more frame rendering times 352, UI rendering times for rendered frames 356, frame presentation times 360, display data 354, UI rendering times for interpolated frames 358, interpolated frame generation times 362, or any combination thereof. For example, timing circuitry 126 combines the frame rendering times 352, UI rendering times for rendered frames 356, frame presentation times 360, display data 354, UI rendering times for interpolated frames 358, and interpolated frame generation times 362 associated with the first rendered frame 305, second rendered frame 315, and interpolated frame 325 to determine the length of the delay in presenting interpolated frame 325. Using the determined length of the delay in presenting interpolated frame 325, timing circuitry 126 determines a corresponding interpolated frame timing 130 for the interpolated frame 325. As an example, timing circuitry 126 compares the determined length of the delay in presenting interpolated frame 122 to the target framerate, refresh rate of display 134 (e.g., as indicated in display data 354), or both to determine an interpolated frame timing 130 for interpolated frame 325. Timing circuitry 126 then provides the interpolated frame timing 130 to display circuitry 364 which provides data representing interpolated frame 325 to display 134, a buffer, or both according to the interpolated frame timing 130.

Within example operation 300, in some embodiments, timing circuitry 126 is configured to determine one or more frame rendering times 352, UI rendering times for rendered frames 356, frame presentation times 360, display data 354, UI rendering times for interpolated frames 358, interpolated frame generation times 362, or any combination thereof concurrently with rendering circuitry 346 rendering rendered frames 305, 315; post-processing circuitry 120 rendering a UI 348 in a rendered frame 305, 315 or interpolated frame 325; interpolation circuitry 230 generating interpolated frame 325; display circuitry 364 providing frame data to a display 134 or buffer; or any combination thereof.

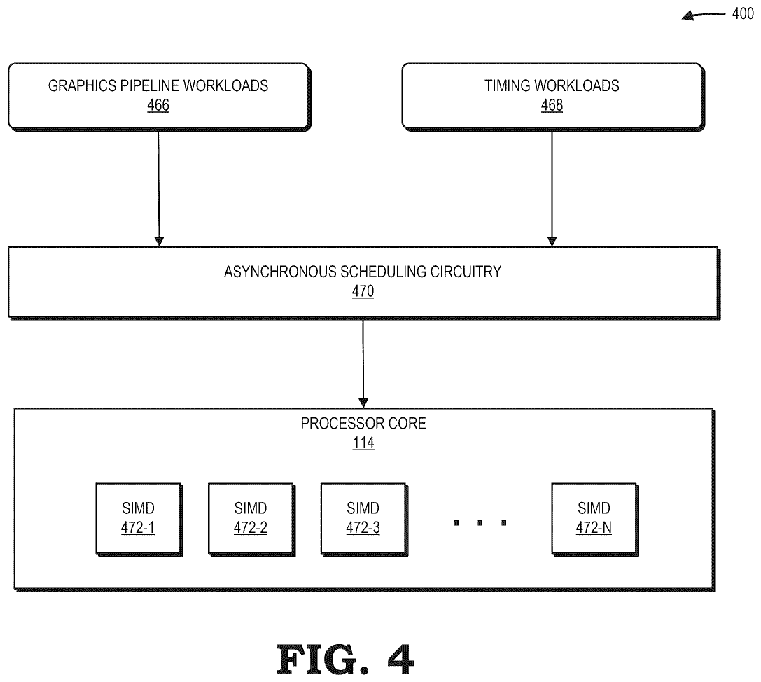

Referring now to FIG. 4, an example operation 400 for determining timing data using asynchronous computing is presented, in accordance with some embodiments. In embodiments, example operation 400 is implemented in processing system 100 by AU 112. According to embodiments, example operation 400 includes asynchronous scheduling circuitry 470 receiving graphics pipeline workloads 466 and timing workloads 468. Such asynchronous scheduling circuitry 470, for example, is implemented within an asynchronous command processor of AU 112 and is configured to schedule instructions such that a group of SIMD units 472 (e.g., a wavefront) concurrently executes a first wave and at least a portion of a second wave. A graphics pipeline workload 466, for example, includes groups of instructions (e.g., waves) that, when executed by a group of SIMD units 472, implement one or more stages 201 to 213 of example graphics pipeline 200 such that one or more rendered frames 118 are rendered, one or more UIs 348 are rendered in a frame, one or more interpolated frames 122 are generated, or any combination thereof. Further, a timing workload 468, for example, includes groups of instructions (e.g., waves) that, when executed by a group of SIMD units 472, implement one or more timing operations such that one or more rendering metrics 128 (e.g., frame rendering times 352, UI rendering times for rendered frames 356, frame presentation times 360, display data 354, UI rendering times for interpolated frames 358, interpolated frame generation times 362) are determined, one or more interpolated frame timings 130 are determined, or both.

Within example operation 400, in embodiments, asynchronous scheduling circuitry 470 is configured to first schedule a first wave (e.g., group of instructions) from graphics pipeline workload 466 for execution on a group of SIMD units 472-1, 472-2, 472-3, 472-N (e.g., a wavefront). For example, asynchronous scheduling circuitry 470 provides data (e.g., one or more operations, operands, instructions, variables, register files) to one or more of the SIMD units 472 such that the SIMD units 472 execute the first wave of graphics pipeline workloads 466. Further, asynchronous scheduling circuitry 470 is configured to schedule at least a portion of a second wave from timing workloads 468 for concurrent execution on the group of SIMD units 472 with the first wave of graphics pipeline workloads 466. As an example, in some embodiments, the first wave of graphics pipeline workloads 466 does not require each SIMD unit 472 to perform an operation for the execution of the first wave of the graphics pipeline workloads 466. Under such circumstances, asynchronous scheduling circuitry 470 then schedules the SIMD units 472 in the group of SIMD units 472 not assigned to the first wave of the graphics pipeline workloads 466 to concurrently execute at least a portion of the second wave of the timing workloads 468. In this way, asynchronous scheduling circuitry 470 is configured to concurrently execute two or more waves on a single wavefront, allowing timing operations from the timing workloads 468 to be performed concurrently with graphics operations from the graphics pipeline workloads 466. Further, performing the timing operations from the timing workloads 468 and the graphics operations from the graphics pipeline workloads 466 concurrently helps reduce the processing resources needed to execute the timing operations and the graphics operations and increases processing efficiency. Though the example embodiment presented in FIG. 4 shows the group of SIMD units as including four SIMD units 472-N representing an N number of SIMD units 472, in other embodiments, a group of SIMD units 472 can include any number of SIMD units 472.

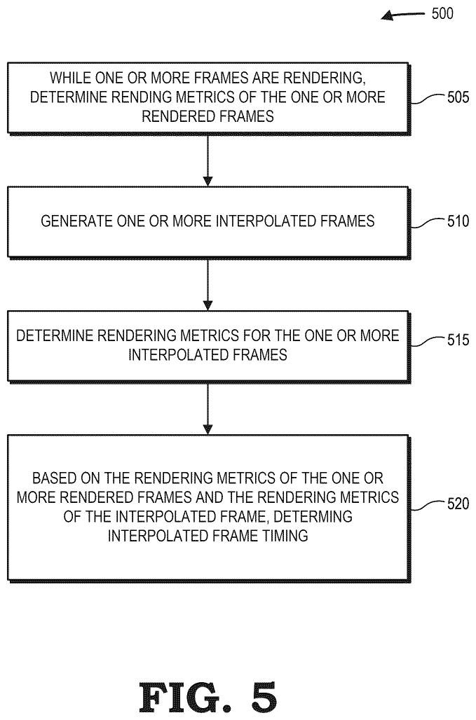

Referring now to FIG. 5, an example method 500 for determining timing data for the presentation of interpolated frames is presented, in accordance with some embodiments. In embodiments, example method 500 is implemented in processing system 100 by AU 112. At block 505, AU 112 is configured to render one or more rendered frames 118. For example, AU 112 is configured to implement one or more stages 201 to 213 of example graphics pipeline 200 so as to render one or more rendered frames 118. After rendering a rendered frame, for example, AU 112 is configured to store frame data representing the rendered frame in frame buffer 226. Additionally, in embodiments, after rendering a rendered frame, AU 112 is configured to render a UI 348 within the rendered frame so as to, for example, provide a head-up display within the rendered frame. Further, at block 505, as AU 112 continues to render additional frames, AU 112 (e.g., timing circuitry 126) is configured to determine one or more rendering metrics 128 associated with one or more of the rendered frames. For example, AU 112 determines the frame rendering times 352, UI rendering times for rendered frames 356, frame presentation times, or any combination thereof for one or more of the rendered frames.

At block 510, AU 112 is configured to generate one or more interpolated frames 122 using one or more rendered frames rendered at block 505. For example, at block 510, AU 112 first retrieves colors values and depth values for a first rendered frame from a first color buffer 220 and a first depth buffer 222 and colors values and depth values for a second rendered frame from a second color buffer 220 and a second depth buffer 222. After retrieving the color values and the depth values for the first rendered frame and the second rendered frame, AU 112 generates an interpolated frame 122 representing a scene temporally between, spatially between, or both temporally between and spatially between, the first and second rendered frame. As an example, AU 112 generates an interpolated frame 122 based on the color values and the depth values of the first and second rendered frames. To this end, as an example, AU 112 is configured to generate one or more motion vectors 124 based on the color values and the depth values of the first and second rendered frames. For example, AU 112 implements one or more motion estimation techniques (e.g., block-matching algorithms, phase correlation methods, pixel recursive algorithms, optical flow methods) using the color values and the depth values of the first and second rendered frames as inputs to generate one or more motion vectors 124. Based on the motion vectors 124, AU 112 then synthesizes the color values and depth values of the interpolated frame 122. As an example, AU 112 implements one or more machine machine-learning models, neural networks (e.g., artificial neural networks, convolution neural networks, recurrent neural networks), or both configured to output color values and depth values for each pixel of the interpolated frame 122 based on receiving the motion vectors 124, the color values of the first and second frames, and the depth values of the first and second frames as inputs. In embodiments, after generating the interpolated frame 122, AU 112 is configured to render a UI 348 within the interpolated frame 122 so as to, for example, provide a head-up display within the rendered frame. After rendering the UI 348 within the interpolated frame 122, AU 112 stores the interpolated frame 122 in the frame buffer 226.

At block 515, AU 112 (e.g., timing circuitry 126) is configured to determine one or more rendering metrics 128 associated with the interpolated frame 122. For example, AU 112 is configured to determine the interpolated frame generation time 362, UI rendering time for interpolated frames 358, or both for the interpolated frame 122. At block 520, AU 112 is configured to determine an interpolated frame timing 130 for the interpolated frame 122 based on the rendering metrics determined at blocks 505, 515. For example, in embodiments, AU 112 is configured to determine an interpolated frame timing 130 based on the frame rendering times 352, UI rendering times for rendered frames 356, or both of the first and second rendered frames and also based on the interpolated frame generation times 362, UI rendering times for interpolated frames 358, or both of the interpolated frame 122. Additionally, in some embodiments, at block 520, AU 112 is configured to determine further rendering metrics 128, for example, display data 354 associated with a display 134, frame presentation times 360 of one or more previously displayed frames (e.g., rendered frames, interpolated frames 122), or both.

Still referring to block 520, to determine an interpolated frame timing 130 for an interpolated frame 122 based on the rendering metrics 128, in embodiments, AU 112 is configured to first determine the length of a delay in presenting the interpolated frame 122. To this end, as an example, AU 112 is configured to add two or more determined rendering metrics 128 associated with the interpolated frame 122 (e.g., associated with the interpolated frame 122 or the rendered frames 118 used to generate the interpolated frame 122) to determine the length of the delay in presenting the interpolated frame 122. AU 112 then compares the length of the delay to the target framerate of the rendered frames 118, the refresh rate of a display 134, or both to determine an interpolated frame timing 130 for the interpolated frame. As an example, based on a comparison of the length of the delay in presenting the interpolated frame 122 to the target framerate of the rendered frames 118, the refresh rate of a display 134, or both, AU 112 determines an interpolated frame timing 130 that causes the interpolated frame 122 to be presented in accordance with the target framerate, the refresh rate of a display 134, or both.

In some embodiments, the apparatus and techniques described above are implemented in a system including one or more integrated circuit (IC) devices (also referred to as integrated circuit packages or microchips), such as the AU 112 described above with reference to FIGS. 1-5. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A processing system comprising:
an accelerator unit (AU) configured to:
generate an interpolated frame based on a first rendered frame and a second rendered frame;
determine an interpolated frame timing based on one or more rendering metrics indicating timing information associated with the first rendered frame and the second rendered frame; and
provide the interpolated frame to a display based on the interpolated frame timing.

2. The processing system of claim 1, wherein the AU includes an asynchronous scheduling circuitry configured to schedule instructions such that the one or more rendering metrics are determined concurrently with rendering one or more frames.

3. The processing system of claim 1, wherein the AU is configured to:
determine the interpolated frame timing based on a comparison of the one or more rendering metrics to a target framerate.

4. The processing system of claim 1, wherein the one or more rendering metrics include a rendering time of the first rendered frame and a rendering time of the second rendered frame.

5. The processing system of claim 1, wherein the AU is configured to:
render a user interface (UI) within the first rendered frame.

6. The processing system of claim 5, wherein the one or more rendering metrics include a UI rendering time of the first rendered frame.

7. The processing system of claim 1, wherein the AU is configured to:
determine a delay in presenting the interpolated frame based on the one or more rendering metrics; and
determine the interpolated frame timing based on the delay.

8. A method, comprising:
generating an interpolated frame based on a first rendered frame and a second rendered frame;
determining an interpolated frame timing based on one or more rendering metrics indicating timing information associated with the first rendered frame and the second rendered frame; and
providing the interpolated frame to a display based on the interpolated frame timing.

9. The method of claim 8, further comprising:
scheduling, at an asynchronous scheduling circuitry, instructions such that the one or more rendering metrics are determined concurrently with rendering one or more frames.

10. The method of claim 8, wherein determining the interpolated frame timing comprises:
determining the interpolated frame timing based on a comparison of the one or more rendering metrics to a refresh rate of the display.

11. The method of claim 8, wherein the one or more rendering metrics include a rendering time of the first rendered frame and a rendering time of the second rendered frame.

12. The method of claim 8, further comprising:
rendering a user interface (UI) within the interpolated frame.

13. The method of claim 12, wherein the one or more rendering metrics includes a UI rendering time of the interpolated frame.

14. The method of claim 8, further comprising:
determining a delay in presenting the interpolated frame based on the one or more rendering metrics; and
determining the interpolated frame timing based on the delay.

15. An accelerator unit (AU) comprising:
one or more processor cores configured to:
determine an interpolated frame timing based on one or more rendering metrics indicating timing information associated with an interpolated frame; and
provide the interpolated frame to a display based on the interpolated frame timing.

16. The AU of claim 15, further comprising:
an asynchronous scheduling circuitry configured to schedule instructions such that the one or more rendering metrics are determined concurrently with rendering one or more frames.

17. The AU of claim 15, wherein the one or more processor cores are configured to:
determine the interpolated frame timing based on a comparison of the one or more rendering metrics to a target framerate.

18. The AU of claim 15, wherein the one or more rendering metrics include a generation time of the interpolated frame.

19. The AU of claim 15, wherein the one or more processor cores are configured to:
render a user interface (UI) within the interpolated frame.

20. The AU of claim 19, wherein the one or more rendering metrics include a UI rendering time of the interpolated frame.
